(19) United States
(12) Patent Application Publication
(10) Pub. No.: US 2026/0141268 A1
(43) Pub. Date: May 21, 2026

(54) INFORMATION PROCESSING DEVICE, INFORMATION PROCESSING METHOD, AND RECORDING MEDIUM

(71) Applicant: NEC Corporation, Tokyo (JP)

(72) Inventor: Yuichi YANO, Tokyo (JP)

(73) Assignee: NEC Corporation, Tokyo (JP)

(21) Appl. No.: 19/382,351

(22) Filed: Nov. 7, 2025

(30) Foreign Application Priority Data
Nov. 20, 2024 (JP) 2024-202308

(51) Int. Cl. G06N 5/025

(52) U.S. Cl. CPC G06N 5/025

(57) ABSTRACT

In an information processing device, an extraction means extracts entities and a relationship between the entities from natural language data. A determination means predicts the relationship between the entities using a link prediction model, thereby determining truthfulness between the entities. A graph construction means adds the relationship between the entities determined to be true by the determination means to a knowledge graph, and does not add the relationship between the entities determined to be false by the determination means to the knowledge graph. For example, the constructed knowledge graph can be used in machine learning to perform various prediction tasks and to support decision-making related to prediction tasks.

### INCORPORATION BY REFERENCE

This application is based upon and claims the benefit of priority from Japanese patent application No. 2024-202308, filed on November 20, 2024, the disclosure of which is incorporated herein in its entirety by reference.

### TECHNICAL FIELD

The present disclosure relates to a technique of constructing a knowledge graph.

### BACKGROUND ART

Knowledge graphs that represent knowledge in various fields have been developed and utilized. A knowledge graph is constructed by, for example, extracting entities and relationships between the entities from text data. Patent Document 1 discloses a technique of extracting entities and relationships between the entities from electronic medical records and generating a set of entities and links between the entities.

Patent Document 1: Japanese Patent 2021-007031 A

### SUMMARY

However, even in a case of using the technique disclosed in Patent Document 1, a highly accurate knowledge graph may not necessarily be constructed.

An object of the present disclosure is to provide an information processing device capable of constructing a highly accurate knowledge graph.

According to an example aspect of the present invention, there is provided an information processing device, including:

at least one memory configured to store instructions; and

at least one processor configured to execute the instructions to:

extract entities and a relationship between the entities from natural language data;

determine truthfulness between the entities by predicting the relationship between the entities using a link prediction model; and

add the relationship between the entities determined to be true to a knowledge graph and not add the relationship between the entities determined to be false to the knowledge graph.

According to another example aspect of the present invention, there is provided an information processing method including:

extracting entities and a relationship between the entities from natural language data;

determining truthfulness between the entities by predicting the relationship between the entities using a link prediction model; and

adding the relationship between the entities determined to be true to a knowledge graph and not adding the relationship between the entities determined to be false to the knowledge graph.

According to a further example aspect of the present invention, there is provided a recording medium recording a program for causing a computer to execute processing including:

extracting entities and a relationship between the entities from natural language data;

determining truthfulness between the entities by predicting the relationship between the entities using a link prediction model; and

adding the relationship between the entities determined to be true to a knowledge graph and not adding the relationship between the entities determined to be false to the knowledge graph.

According to the present disclosure, it becomes possible to provide an information processing device capable of constructing a highly accurate knowledge graph.

### BRIEF DESCRIPTION OF THE DRAWINGS

FIG. 1 is a diagram conceptually illustrating an information processing device according to the present disclosure;

FIG. 2 is a block diagram illustrating a hardware configuration of the information processing device according to the present disclosure;

FIG. 3 is a block diagram illustrating a functional configuration of the information processing device according to the present disclosure;

FIG. 4 is an example of natural language data;

FIG. 5 is an example of an extracted entity;

FIG. 6 is an example of a prompt by a relationship extraction unit;

FIG. 7 is an example of an LLM response;

FIG. 8 is a flowchart of a process performed by the information processing device according to the present disclosure;

FIG. 9 is a block diagram illustrating a functional configuration of another information processing device according to the present disclosure; and

FIG. 10 is a flowchart of a process performed by the another information processing device according to the present disclosure.

### EXAMPLE EMBODIMENTS

Hereinafter, preferred example embodiments of the present disclosure will be described with reference to the drawings.

### First Example Embodiment

### Overall Configuration

In the fields of medicine and drug discovery, there is a wealth of data written in natural language, such as papers and electronic medical records. By constructing a knowledge graph from such natural language data, a relationship between data may be expressed, which may be utilized for advanced search, predictive tasks, and the like.

The knowledge graph is constructed by using, for example, a large language model (LLM). However, according to the method described above, there has been a possibility that a knowledge graph different from the fact described in the original natural language data is constructed if the LLM causes hallucination (i.e., if the LLM generates erroneous information).

In view of the above, in the present example embodiment, a process of checking truthfulness of a relationship between entities is included at the time of constructing the knowledge graph. As a result, a highly accurate knowledge graph based on the fact is constructed.

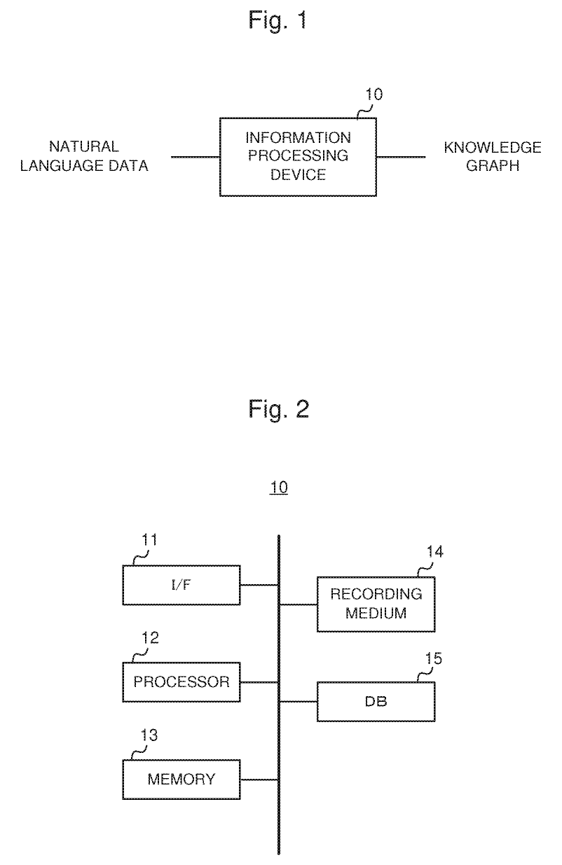

FIG. 1 is a diagram conceptually illustrating an information processing device according to the present example embodiment. An information processing device 10 constructs a knowledge graph from the input natural language data, such as papers. First, the information processing device 10 extracts, using the LLM, a list of triples (node, edge, node) from the natural language data. A node represents an entity, and an edge represents a relationship between nodes. Next, the information processing device 10 performs link prediction on each triple using a link prediction model, and determines truthfulness of the relationship between the nodes. The information processing device 10 adds the triple in which the relationship between the nodes is determined to be true to the knowledge graph, and excludes the triple in which the relationship between the nodes is determined to be false without adding it to the knowledge graph. In this manner, the process of performing the link prediction on the information (triples) obtained from the LLM to check the truthfulness of the relationship between the nodes is included, whereby the information processing device 10 is enabled to construct a highly accurate knowledge graph.

While a knowledge graph in the fields of medicine and drug discovery is constructed in the present example embodiment, the target field is not limited thereto, and for example, it is applicable to other fields such as material development, pesticide development, and the like.

### Hardware Configuration

FIG. 2 is a block diagram illustrating a hardware configuration of the information processing device 10 according to the first example embodiment. The information processing device 10 is an exemplary information processing device. As illustrated in the drawing, the information processing device 10 includes an interface (I/F) 11, a processor 12, a memory 13, a recording medium 14, and a database (DB) 15.

The I/F 11 exchanges data with an external device. Specifically, the I/F 11 obtains, from the external device, natural language data to be used by the information processing device 10.

The processor 12 is a computer such as a central processing unit (CPU), and takes overall control of the information processing device 10 by executing a program prepared in advance. The processor 12 may be a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The processor 12 executes a knowledge graph construction process to be described later.

The memory 13 includes a read only memory (ROM), a random access memory (RAM), and the like. The memory 13 is also used as a work memory during execution of various types of processing by the processor 12.

The recording medium 14 is a non-volatile non-transitory recording medium, such as a disk-shaped recording medium, a semiconductor memory, or the like, and is detachable from the information processing device 10. The recording medium 14 records various programs to be executed by the processor 12. In a case where the information processing device 10 executes various types of processing, a program recorded in the recording medium 14 is loaded into the memory 13, and is executed by the processor 12. The DB 15 stores an existing knowledge graph to be described later. The DB 15 may store a link prediction model.

In addition to the above, the information processing device 10 may include a display device such as a liquid crystal display, and an input device such as a keyboard and a mouse. The display device and the input device are used by an administrator of the information processing device 10 to perform necessary management, for example.

### Functional Configuration

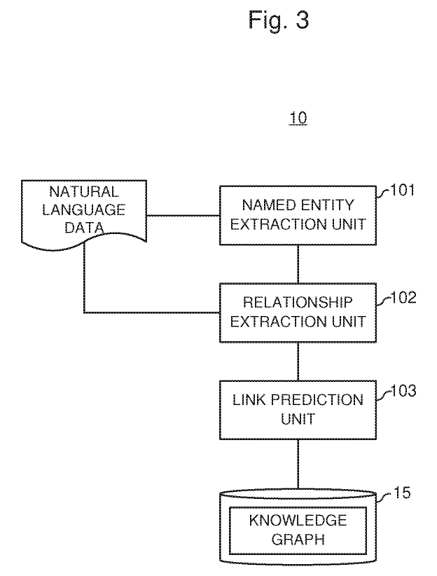

FIG. 3 is a block diagram illustrating a functional configuration of the information processing device 10 according to the first example embodiment. The information processing device 10 functionally includes a named entity extraction unit 101, a relationship extraction unit 102, and a link prediction unit 103.

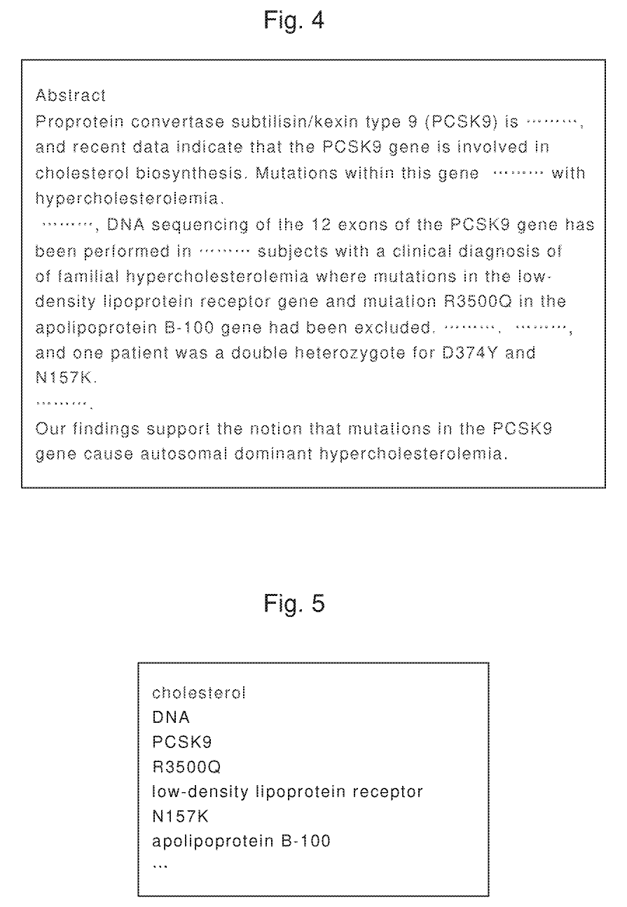

The natural language data is input to the information processing device 10 through the I/F 11. The natural language data is input to the named entity extraction unit 101 and to the relationship extraction unit 102. FIG. 4 is an example of the natural language data. The natural language data of FIG. 4 is a medical paper, and is obtained from, for example, a medical literature search database.

The named entity extraction unit 101 extracts a named entity from the natural language data using a model such as an LLM. The named entity is a proper noun or a numerical expression such as a date, time, or the like. In the fields of medicine and drug discovery, examples of the named entity include a disease name, a drug name, a gene name, and a protein name. The named entity extracted by the named entity extraction unit 101 is treated as an entity candidate in the knowledge graph. The named entity extraction unit 101 outputs the extracted named entity (which will also be referred to as an “entity” hereinafter) to the relationship extraction unit 102.

FIG. 5 is an example of the extracted entity. In FIG. 5, the named entity extraction unit 101 extracts, from the natural language data of FIG. 4, entities such as cholesterol, DNA, PCSK9, R3500Q, and the like.

The relationship extraction unit 102 extracts a relationship between entities from the natural language data based on the natural language data and the entities. The relationship extraction unit 102 extracts a list of triples as a relationship between entities.

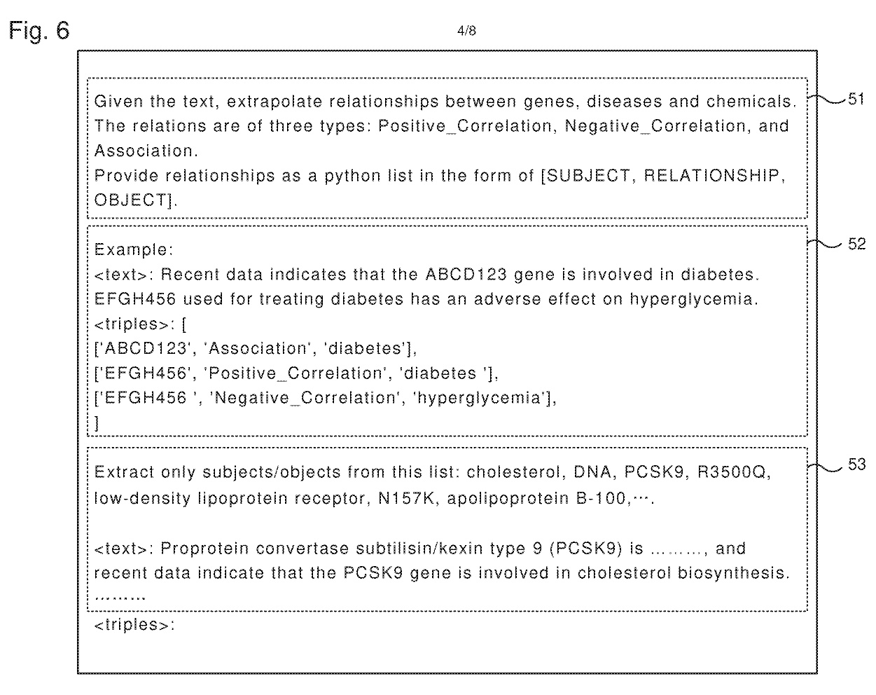

Specifically, the relationship extraction unit 102 creates a prompt as illustrated in FIG. 6, and inputs the created prompt to the LLM. The prompt is to instruct the LLM to extract the triples from the natural language data. Then, the relationship extraction unit 102 obtains a response (i.e., list of triples) to the prompt from the LLM. The relationship extraction unit 102 outputs the LLM response to the link prediction unit 103.

FIG. 6 is an example of the prompt by the relationship extraction unit 102. The prompt of FIG. 6 includes a directive 51, a specific example 52, and a context 53. The directive 51 is an instruction sentence for the LLM. The directive 51 includes text of instructing inference of a relationship between entities from the natural language data, text of instructing an output of a response in a form of a triple, and the like. The specific example 52 is an example of processing to be executed by the LLM. With such an example being present, the accuracy of the LLM response may be improved. The context 53 is an information source for the LLM to generate a response, and includes the entities input from the named entity extraction unit 101 and the natural language data.

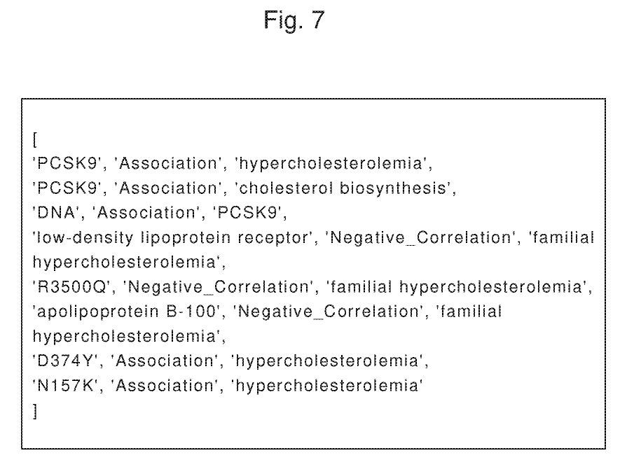

FIG. 7 illustrates an example of the LLM response. As illustrated in FIG. 7, the relationship extraction unit 102 obtains a list of triples as an LLM response.

Returning to FIG. 3, the link prediction unit 103 performs the link prediction on each triple using a link prediction model prepared in advance, and estimates a score of each triple.

The link prediction model is a model obtained by training an existing knowledge graph with, for example, a machine learning algorithm such as TransE or DistMult. The link prediction model is trained to predict a relationship between unlinked nodes in the existing knowledge graph. The existing knowledge graph is an existing knowledge graph in the fields of medicine and drug discovery. It is assumed that the existing knowledge graph is constructed from, for example, natural language data such as medical papers, drug discovery papers, and the like, and is completed to some extent.

Specifically, first, the link prediction unit 103 generates, as a query, text in which an edge is missing among the three elements (node, edge, node) of the triple. For example, the link prediction unit 103 generates a query (DNA, ?, PCSK9) from a triple (DNA, Association, PCSK9). “?” indicates missing.

Next, the link prediction unit 103 inputs the generated query to the link prediction model. The link prediction model outputs a missing edge candidate and its prediction score as a response to the query. The prediction score is represented in a range of 0 to 1. For example, as a response to the query (DNA, ?, PCSK9), the link prediction model outputs an edge candidate “Association” and its prediction score “0.7”, outputs an edge candidate “Positive_Correlation” and its prediction score “0.2”, and outputs an edge candidate “Negative_Correlation” and its prediction score “0.1”.

Next, the link prediction unit 103 estimates a score of the triple based on the response of the link prediction model. For example, the link prediction unit 103 extracts the same edge as the original triple from the plurality of edge candidates, and sets the prediction score of the edge as the score of the triple. In the example described above, the original triple is “DNA, Association, PCSK9”, and the prediction score of the edge candidate “Association” is “0.7”. Thus, the link prediction unit 103 estimates that the score of the triple (DNA, Association, PCSK9) is “0.7”.

The link prediction unit 103 determines the truthfulness of the relationship between the nodes based on the score of each triple. “True” indicates that the relationship between the nodes (triple) is established, and “false” indicates that the relationship between the nodes (triple) is not established. The link prediction unit 103 constructs a knowledge graph based on a result of the truthfulness determination.

Specifically, if the score of the triple is equal to or higher than a predetermined threshold, the link prediction unit 103 determines that the relationship between the nodes is true, and adds the triple to the knowledge graph. On the other hand, if the score of the triple is lower than the predetermined threshold, the link prediction unit 103 determines that the relationship between the nodes is false, and excludes the triple without adding it to the knowledge graph.

The knowledge graph to which the triple is to be added is, for example, an existing knowledge graph used to train the link prediction model. The link prediction unit 103 determines the truthfulness of the relationship between the nodes, and then adds new relationships to the existing knowledge graph. As a result, the accuracy of the knowledge graph may improve.

The named entity extraction unit 101 and the relationship extraction unit 102 may use OpenAI’s Generative Pre-trained Transformer (GPT) or the like as the LLM. The LLMs to be used by the named entity extraction unit 101 and the relationship extraction unit 102 may be the same model, or may be different models. For example, the named entity extraction unit 101 may use a trained language model specialized in a domain (fields of medicine and drug discovery in the present example embodiment).

In the configuration described above, the named entity extraction unit 101 and the relationship extraction unit 102 are examples of an extraction means, and the link prediction unit 103 is an example of a determination means and a graph construction means.

### Knowledge Graph Construction Process

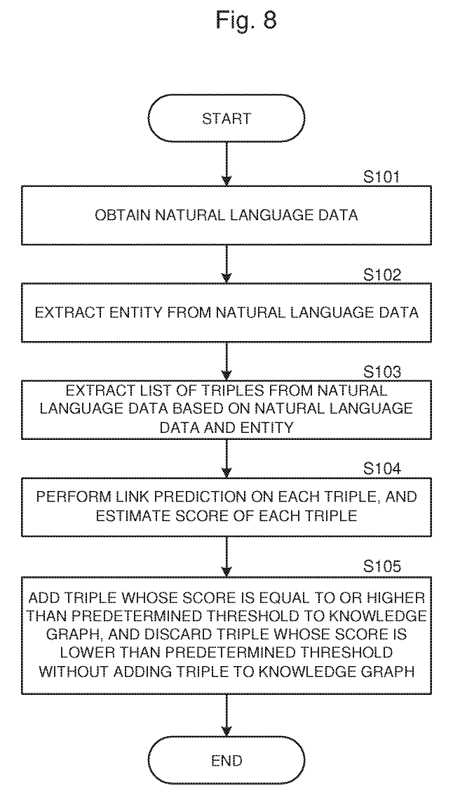

Next, a process of constructing the knowledge graph as described above will be described. FIG. 8 is a flowchart of the knowledge graph construction process performed by the information processing device 10. This process is achieved by the processor 12 illustrated in FIG. 2 executing a program prepared in advance and operating as each element illustrated in FIG. 3.

First, the natural language data is input to the information processing device 10 through the I/F 11 (step S101). The natural language data is input to the named entity extraction unit 101 and to the relationship extraction unit 102.

Next, the named entity extraction unit 101 extracts entities from the natural language data (step S102). The named entity extraction unit 101 outputs the extracted entities to the relationship extraction unit 102. Next, the relationship extraction unit 102 extracts a list of triples from the natural language data based on the natural language data and the entities (step S103). The relationship extraction unit 102 outputs the list of the triples to the link prediction unit 103.

Next, the link prediction unit 103 performs the link prediction on each triple using the link prediction model prepared in advance, and estimates a score of each triple (step S104). Next, if the score of the triple is equal to or higher than a predetermined threshold, the link prediction unit 103 adds the triple to the knowledge graph. On the other hand, if the score of the triple is lower than the predetermined threshold, the link prediction unit 103 discards the triple without adding it to the knowledge graph (step S105). Then, the process is terminated.

### Application Example

The knowledge graph constructed by the information processing device 10 may be utilized for a semantic search, for example. The constructed knowledge graph may be utilized for various predictive tasks by being used for machine learning.

### Second Example Embodiment

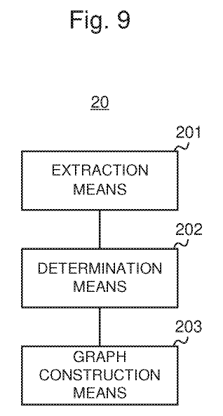

FIG. 9 is a block diagram illustrating a functional configuration of an information processing device according to a second example embodiment. An information processing device 20 includes an extraction means 201, a determination means 202, and a graph construction means 203.

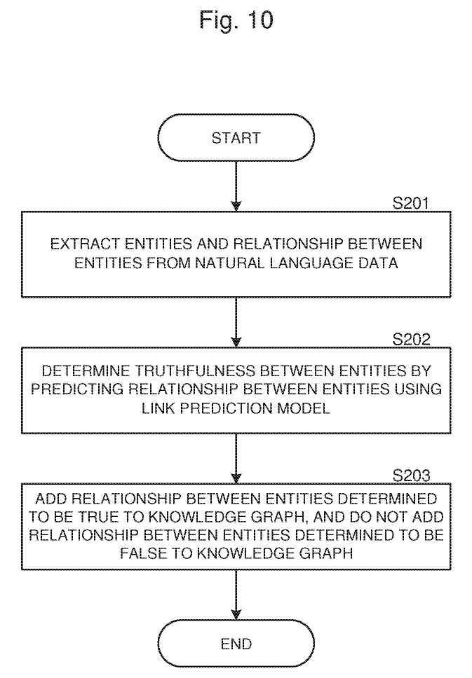

FIG. 10 is a flowchart of a process performed by the information processing device according to the second example embodiment. The extraction means 201 extracts entities and a relationship between the entities from natural language data (step S201). The determination means 202 predicts the relationship between the entities using a link prediction model, thereby determining truthfulness between the entities (step S202). The graph construction means 203 adds the relationship between the entities determined to be true by the determination means to a knowledge graph, and does not add the relationship between the entities determined to be false by the determination means to the knowledge graph (step S203).

According to the information processing device according to the second example embodiment, a highly accurate knowledge graph may be constructed.

Some or all of the example embodiments described above may also be described as, but are not limited to, the following Supplementary Notes.

### Supplementary note 1

An information processing device comprising:

an extraction means for extracting entities and a relationship between the entities from natural language data;

a determination means for determining truthfulness between the entities by predicting the relationship between the entities using a link prediction model; and

a graph construction means for adding the relationship between the entities determined to be true by the determination means to a knowledge graph and not adding the relationship between the entities determined to be false by the determination means to the knowledge graph.

### Supplementary note 2

The information processing device according to supplementary note 1, wherein the link prediction model outputs the relationship between the entities as a score, and the determination means determines that the relationship between the entities is true in a case where the score is equal to or higher than a predetermined threshold, and determines that the relationship between the entities is false in a case where the score is lower than the predetermined threshold.

### Supplementary note 3

The information processing device according to supplementary note 2, wherein the extraction means extracts a list of a triple as the relationship between the entities, the determination means obtains the score of each triple using the link prediction model, and the graph construction means adds the triple having the score equal to or higher than the predetermined threshold to the knowledge graph, and does not add the triple having the score lower than the predetermined threshold to the knowledge graph.

### Supplementary note 4

The information processing device according to supplementary note 3, wherein the triple includes three elements of a first node, an edge, and a second node, and the determination means generates, as a query, data in which the edge is missing among the three elements, inputs the query to the link prediction model, obtains an edge candidate and a prediction score from the link prediction model, and estimates the score of the triple based on the edge candidate and the prediction score.

### Supplementary note 5

The information processing device according to supplementary note 1, wherein the link prediction model includes a model trained to predict a relationship between unlinked entities in a known knowledge graph, and the known knowledge graph includes a known knowledge graph in a same field as the natural language data, and includes the entities of the natural language data.

### Supplementary note 6

The information processing device according to supplementary note 1, wherein the natural language data includes paper data and an electronic medical record.

### Supplementary note 7

The information processing device according to supplementary note 1, wherein the extraction means extracts the entities and the relationship between the entities using a large language model.

### Supplementary note 8

The information processing device according to supplementary note 7, wherein the extraction means extracts the entities using the large language model that has been trained and is specialized in a domain.

### Supplementary note 9

An information processing method to be executed by a computer, the information processing method comprising: performing extraction processing for extracting entities and a relationship between the entities from natural language data; performing determination processing for determining truthfulness between the entities by predicting the relationship between the entities using a link prediction model; and performing graph construction processing for adding the relationship between the entities determined to be true by the determination processing to a knowledge graph and not adding the relationship between the entities determined to be false by the determination processing to the knowledge graph.

### Supplementary note 10

A program for causing a computer to perform a process comprising: extraction processing for extracting entities and a relationship between the entities from natural language data; determination processing for determining truthfulness between the entities by predicting the relationship between the entities using a link prediction model; and graph construction processing for adding the relationship between the entities determined to be true by the determination processing to a knowledge graph and not adding the relationship between the entities determined to be false by the determination processing to the knowledge graph.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

10 Information Processing Device

101 Named Entity Extraction Unit

102 Relationship Extraction Unit

103 Link Prediction Unit

1. An information processing device comprising:
at least one memory configured to store instructions; and
at least one processor configured to execute the instructions to:
extract entities and a relationship between the entities from natural language data;
determine truthfulness between the entities by predicting the relationship between the entities using a link prediction model; and
add the relationship between the entities determined to be true to a knowledge graph and not add the relationship between the entities determined to be false to the knowledge graph.

2. The information processing device according to claim 1, wherein
the link prediction model outputs the relationship between the entities as a score, and
the one or more processors determine that the relationship between the entities is true in a case where the score is equal to or higher than a predetermined threshold, and determine that the relationship between the entities is false in a case where the score is lower than the predetermined threshold.

3. The information processing device according to claim 2, wherein
the one or more processors extract a list of a triple as the relationship between the entities,
the one or more processors obtain the score of each triple using the link prediction model, and
the one or more processors add the triple having the score equal to or higher than the predetermined threshold to the knowledge graph, and do not add the triple having the score lower than the predetermined threshold to the knowledge graph.

4. The information processing device according to claim 3, wherein
the triple includes three elements of a first node, an edge, and a second node, and
the one or more processors generate, as a query, data in which the edge is missing among the three elements, input the query to the link prediction model, obtain an edge candidate and a prediction score from the link prediction model, and estimate the score of the triple based on the edge candidate and the prediction score.

5. The information processing device according to claim 1, wherein
the link prediction model includes a model trained to predict a relationship between unlinked entities in a known knowledge graph, and
the known knowledge graph includes a known knowledge graph in a same field as the natural language data, and includes the entities of the natural language data.

6. The information processing device according to claim 1, wherein the natural language data includes paper data and an electronic medical record.

7. The information processing device according to claim 1, wherein the one or more processors extract the entities and the relationship between the entities using a large language model.

8. The information processing device according to claim 7, wherein the one or more processors extract the entities using the large language model that has been trained and is specialized in a domain.

9. An information processing method comprising:
extracting entities and a relationship between the entities from natural language data;
determining truthfulness between the entities by predicting the relationship between the entities using a link prediction model; and
adding the relationship between the entities determined to be true to a knowledge graph and not adding the relationship between the entities determined to be false to the knowledge graph.

10. A non-transitory computer-readable recording medium recording a program for causing a computer to execute processing comprising:
extracting entities and a relationship between the entities from natural language data;
determining truthfulness between the entities by predicting the relationship between the entities using a link prediction model; and
adding the relationship between the entities determined to be true to a knowledge graph and not adding the relationship between the entities determined to be false to the knowledge graph.
